(19) United States
(12) Patent Application Publication
(10) Pub. No.: US 2010/0000094 A1
(43) Pub. Date: Jan. 7, 2010

(54) POWER TOOL WITH UV ILLUMINATION

(76) Inventor: Rachel Lombardo, Parkton, MD (US)

Correspondence Address: Harness Dickey & Pierce, P.L.C., P.O. Box 828, Bloomfield Hills, MI, 48303, US

(21) Appl. No.: 12/166,089

(22) Filed: Jul. 1, 2008

(51) Int. Cl. B26B 11/00

(52) U.S. Cl. 30/123

(57) ABSTRACT

A handheld power tool can include a tool housing having a trigger assembly. A motor can be disposed in the tool housing. The motor can drive an output member and be activated by the trigger assembly. A cutting member can be driven by the output member. A UV light source can be coupled to the tool housing. The UV light source can project UV light onto an area proximate to the cutting member.

### FIELD

The present teachings relate to a handheld power tool and more particularly relate to a handheld power tool having a UV light source for illuminating markings on a workpiece.

### BACKGROUND

Handheld power tools are provided in many varieties, such as jigsaws for example that can be used to cut a workpiece. In some instances, prior to performing a cutting operation, a user may mark onto a workpiece with a writing instrument a desired cutting path. The cutting path can then be followed by the cutting portion (i.e., saw blade, etc.). Sometimes, it may be difficult for a user to effectively view such markings while performing a cutting operation (or other material working operation, such as drilling) onto the workpiece. Furthermore, while many examples require a cut along a straight line, some applications may require a cutting path that defines curves or other non-linear shapes.

### SUMMARY

A handheld power tool can include a tool housing having a trigger assembly. A motor can be disposed in the tool housing. The motor can drive an output member and be activated by the trigger assembly. A cutting member can be driven by the output member. A UV light source can be coupled to the tool housing. The UV light source can project UV light onto an area proximate to the cutting member.

According to additional features, the handheld power tool can further comprise a shoe member that is coupled to the tool housing. The UV light source can project UV light onto an area of a workpiece generally ahead of the shoe member in a cutting direction. According to other features, the handheld power tool can further comprise a writing instrument operable to place markings onto the workpiece. The markings can correspond to a cutting pattern. The UV light can illuminate the cutting pattern relative to the area proximate to the cutting member. The UV light source can be disposed on the tool housing generally proximate to the cutting member.

According to still other features, the UV light source can be powered by a power source that is internal to the tool housing. The UV light source can also be powered by a common power source as the motor. A switch can selectively electrically connect the UV light source to the common power source. The UV light source can be disposed in a light housing. The light housing can be selectively attached to the tool housing. In one example, the light housing can be removably affixed to the tool housing by fasteners. According to other features, the light housing can be portable and comprise an internal power source.

A method of cutting a work piece with a handheld power tool can include marking a cutting pattern onto the workpiece with a writing instrument. A UV light source associated with the handheld power tool can be activated. The UV light source can emit light that makes the markings of the cutting pattern appear optically brighter relative to the surrounding areas of the workpiece in range of the emitted light. The workpiece can be cut with a cutting member on the tool while the cutting member is directed substantially along the markings.

Further areas of applicability will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings.

FIG. 1 is a front perspective view of an exemplary power hand tool having a UV light source according to one example of the present teachings;

FIG. 2 is a perspective view of an exemplary workpiece having markings drawn on it by a writing instrument;

FIG. 3 is a partial side perspective view of the power hand tool of FIG. 1 and shown cutting through the workpiece of FIG. 2 along the marking lines while the UV light illuminates the markings;

FIG. 4 is an exemplary schematic view of a power tool constructed in accordance to additional features of the present teachings; and

FIG. 5 is an exemplary schematic view of a power tool constructed in accordance to the present teachings and cooperating with a portable UV light source.

### DETAILED DESCRIPTION

The following description is merely exemplary in nature and is not intended to limit the present teachings, their application or uses. It should be understood that throughout the drawings, corresponding reference numerals can indicate like or corresponding parts and features.

Moreover, certain terminology can be used for the purpose of reference only and do not limit the present teachings. For example, terms such as “upper,” “lower,” “above” and “below” can refer to directions in the drawings to which reference is made. Terms such as “front,” “back,” “rear” and “side” can describe the orientation of portions of the component, function, system, etc. within a consistent but arbitrary frame of reference which can be made more clear by reference to the text and the associated drawings describing the component, function, system, etc. under discussion. Such terminology may include the words specifically mentioned above, derivatives thereof and words of similar import. Similarly, the terms “first,” “second” and other such numerical terms referring to structures, systems and/or methods do not imply a sequence or order unless clearly indicated by the context.

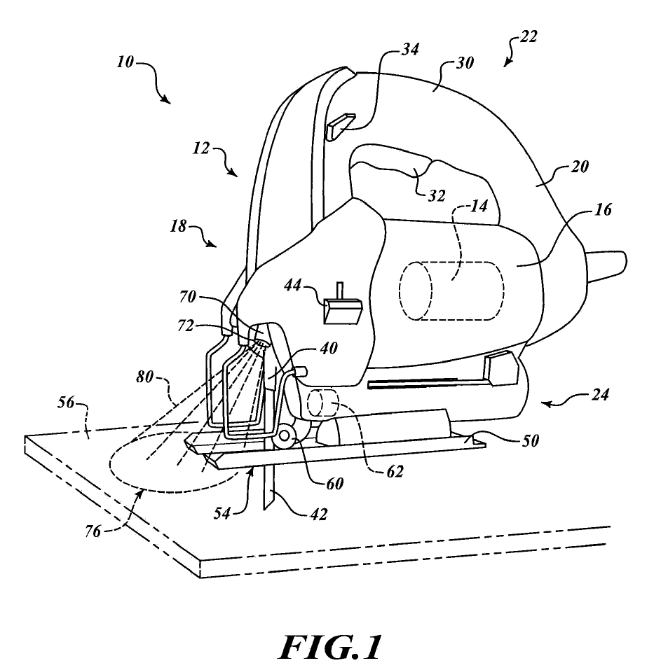

With initial reference to FIG. 1, a power tool constructed in accordance with the present teachings is shown and generally identified at reference numeral 10. The power tool 10 can generally comprise a housing 12 containing a motor 14. The housing 12 can generally comprise a main body 16, a front portion 18, a rear portion 20, an upper portion 22 and a lower portion 24. In one example, the upper portion 22 can define a handle 30 having a trigger assembly 32. A power switch 34 can be provided on the upper portion 22 of the tool 10.

When activated by the trigger assembly 32, the motor 14 can provide a reciprocating and/or pendulum motion to an output member, such as a cutting blade holder 40, on an end of a reciprocating shaft to drive a cutting blade 42. A control member 44 can be provided on the main body 16 of the housing 12. In one example, the control member 44 can control a rate of reciprocation and/or a magnitude of a pendulum motion of the cutting blade 42.

While the handheld power tool 10 is represented in the figures as a jigsaw, the teachings of the present disclosure are also applicable to other handheld power tools, such as, but not limited to, circulating saws, reciprocating saws, scroll saws, miter saw, band saws, portable band saws, rotary tools, cut-out tools, drills, routers, grinders, or any other tool in which an illumination of an area or path would assist the user in seeing a cutting or working line.

A shoe member 50 can be coupled to the lower portion 24 of the housing 12. During use, a bottom surface 54 of the shoe member 50 can abut a workpiece 56, which can be wood, plastic, metal, other suitable materials and one or more combinations thereof and can be in the form of pipe, sheet material, stock material, other suitable forms and/or materials and one or more combinations thereof. The handheld power tool 10 can further comprise a rolling blade guide 60 that can guide the blade 42 during reciprocating motion. A dust blower 62 can be disposed in the housing 12, such as near the lower portion 24. The dust blower 62 can be configured to blow air onto the workpiece 56 in a direction generally proximate to the cutting area of the blade 42 to disperse debris from the workpiece 56 at an area adjacent to the blade 42.

The handheld power tool 10 can further comprise a light source 70 having a light outlet 72. In one example, the light source 70 can be disposed generally on the front portion 18 of the housing 12. The light source 70 according to the present teachings can comprise an ultraviolet (UV) light. The UV light can be in the form of a bulb, a light-emitting diode (LED), or other forms. In one example, the UV light source 70 can include a black light. The light source 70 can be configured to shine light out of the light outlet 72 and onto a work area 76 of the workpiece 56. In one example, the light source 70 can emit a generally wide beam 80 of UV light onto the work area 76 of the workpiece 56. As will become appreciated from the following discussion, the light source 70 can emit the beam 80 onto the work area 76 of the workpiece 56 to illuminate markings drawn by the user onto the workpiece 56 that identify an area of interest such as a desired cut pattern for example.

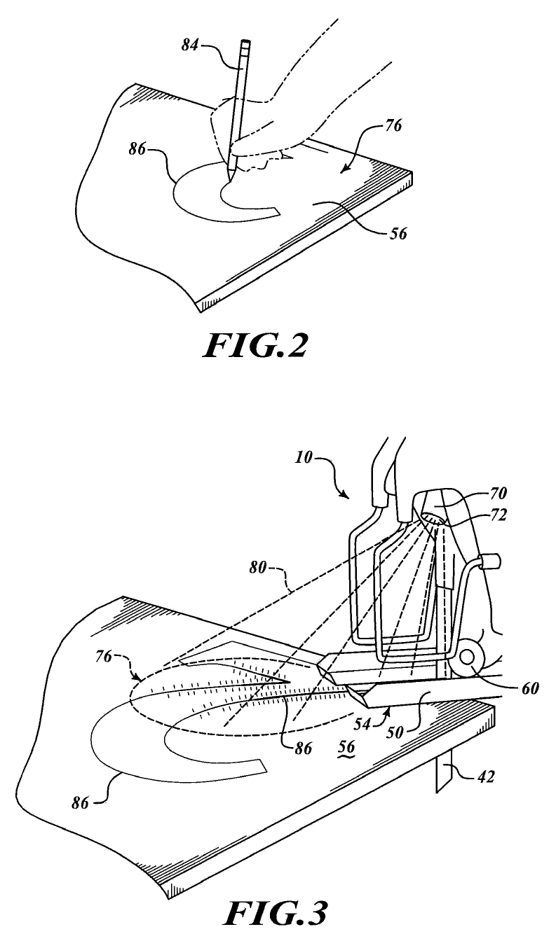

With continual reference to FIG. 1 and additional reference now to FIGS. 2 and 3, the handheld power tool 10 and an exemplary method of using the handheld power tool 10 will be described in greater detail. A writing instrument 84 can be provided for drawing markings 86 onto the workpiece 56. According to various examples, a writing instrument 84 can comprise any writing tool that can mark a workpiece, such as a highlighter, a pencil, a pen, a marker, or other writing tool. According to various examples, the pencil can comprise a graphite pencil, a charcoal pencil, a crayon, a grease pencil, or other variety of pencil. The highlighter, according to various examples, can comprise any color, such as yellow for example. In this way, a user can draw the markings 86 onto the workpiece 56 to identify a desired line of cut.

As can be appreciated, in some examples, it may be desirable to cut along a curved cutting path (such as shown in FIG. 2). According to one advantage of the present teachings, the light source 70 can be adapted to transmit UV light onto the surrounding work area 76 rather than simply project a line of light, such as provided by a laser, for example. By shining on an area, the UV light can shine on markings that are within the work area 76.

As shown in FIG. 3, the handheld power tool 10 is shown cutting the workpiece 56 along the marking 86. The beam 80 of the light source 70 illuminates the markings 86 by way of the UV light. In one example, the UV light can transmit radiation prompting visible effects of fluorescence and phosphorescence. More specifically, the beam 80 of UV light illuminates the markings 86 relative to the surrounding work area 76 to make the markings easily visible by the user. As can be appreciated by those skilled in the art that while the UV light may be projected onto the work area 76 of the workpiece 56, the work area 76 does not necessarily illuminate as would be the case with a conventional incandescent (or other) light bulb. Instead, the UV light will cause the markings 86 to illuminate significantly relative to the remainder of the work area 76 (i.e., areas without the markings 86 but within the work area 76). Also, as can be appreciated, the beam 80 of UV light can effectively illuminate a curved path of the markings 86, such that a user can effectively anticipate movements of the tool 10 as the user cuts through the workpiece 56.

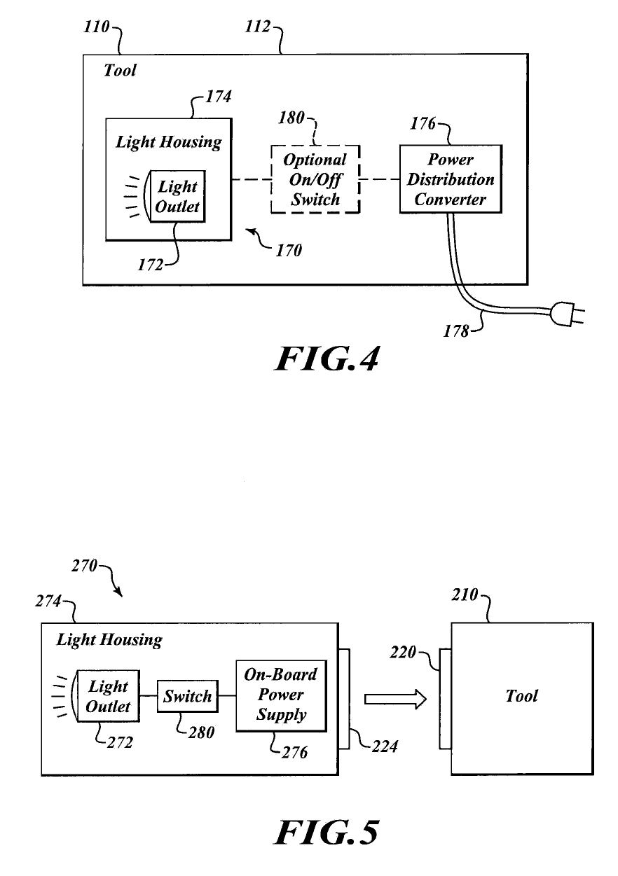

With reference now to FIG. 4, a handheld power tool 110 according to additional features is shown. The power tool 110 can generally define a tool housing 112. While not specifically shown in FIG. 4, the power tool 110 can generally take the form of the handheld power tool 10 described above with respect to FIG. 1. It is appreciated that while specific components shown in the power tool 10 of FIG. 1 have been omitted in the illustration of the power tool 110 of FIG. 4 that they are simply omitted for clarity purposes.

The power tool 110 can comprise a light source 170 having a light outlet 172. The light source 170 having the light outlet 172 can be generally provided as part of a light housing 174. The light source 170 can be configured to emit UV light as described above with respect to the light source 170. The power tool 110 can further comprise a power distributor/converter that can convert alternating current (AC) from a power cord 178 into usable power for the power tool 110. According to the example shown in FIG. 4, the power tool 110 can include an on/off switch 180. The on/off switch 180 can be turned to an “on” position to communicate electrical power from the power distributor/converter 176 to the light source 170. In one example, the light source 170 can be powered by the same source as other components (i.e., the motor) of the power tool 110. As can be appreciated, by turning the on/off switch 180 to an “off” position, a user can disable power communication to the light source 170 when the light source 170 is not needed. It is appreciated that while the power tool 110 has been shown with a standard AC power cord 178, the power tool 110 can alternatively be powered by an onboard power source, such as batteries, for example.

Turning now to FIG. 5, a handheld power tool 210 will be described in cooperation with a portable light source 270. Again, it is appreciated that the power tool 210 can be configured similar to the power tool 10 illustrated in FIG. 1. In this way, features shown and described above with respect to the power tool 10 can likewise be included on the power tool 210 of FIG. 5. According to the example shown in FIG. 5, the power tool 210 can include a receiving member 220 that can selectively couple with an attachment member 224 defined on a light housing 274 of the light source 270. The light source 270 can be configured to transmit UV light, such as described above in relation to the power tools 10 and 110 described above. The light source 270 according to the example of FIG. 5 can be a self-contained light source having an onboard power supply 276 (such as batteries for example) electrically coupled to an on/off switch 280 provided on the light housing 274. The light source 270 can define a light outlet 272 for emitting UV light onto a workpiece.

The receiving member 220 and attachment member 224 can take various forms. In one example, the receiving member 220 and the attachment member 224 can comprise a combination of fasteners that are configured to selectively mate with complementary features for securing the light source 270 to the tool 210. It is appreciated that the receiving member 220 and the attachment member 224 can take on other forms, such as, but not limited to, magnets. It is contemplated that the receiving member 220 can be arranged such that when the attachment member 224 is coupled with the receiving member 220, the light outlet 272 is aligned for emitting the UV light onto the work area (i.e., work area 76, FIG. 1). According to other features, it is contemplated that the light outlet 272 can be adjustable, such that a user can alter the direction of emitted light from the light outlet 272. It is also contemplated that the light source 70 (FIG. 1) and the light source 170 (FIG. 4) can also include an adjustable light outlet 72 and 172, respectively, such that a user can adjust the direction that the light is emitted onto in the work area 76 of the workpiece 56.

While specific aspects have been described in the specification and illustrated in the drawings, it will be understood by those skilled in the art that various changes can be made and equivalents can be substituted for elements and components thereof without departing from the scope of the present teachings, as defined in the claims. Furthermore, the mixing and matching of features, elements, components and/or functions between various aspects of the present teachings are expressly contemplated herein so that one skilled in the art will appreciate from the present teachings that features, elements, components and/or functions of one aspect of the present teachings can be incorporated into another aspect, as appropriate, unless described otherwise above. Moreover, many modifications may be made to adapt a particular situation, configuration or material to the present teachings without departing from the essential scope thereof. Therefore, it is intended that the present teachings not be limited to the particular aspects illustrated by the drawings and described in the specification as the best mode presently contemplated for carrying out the present teachings, but that the scope of the present teachings include many aspects and examples following within the foregoing description and the appended claims.

What is claimed is:

1. A handheld power tool comprising:
a tool housing having a trigger assembly;
a motor disposed in the tool housing and driving an output member, the motor activated by the trigger assembly;
a cutting member driven by the output member; and
a UV light source coupled to the tool housing that projects UV light onto an area proximate to the cutting member.

2. The handheld power tool of claim 1, further comprising a shoe member coupled to the tool housing wherein the UV light source projects UV light onto an area of a workpiece generally ahead of the shoe member in a cutting direction.

3. The handheld power tool of claim 2, further comprising a writing instrument operable to place markings onto the workpiece, the markings corresponding to a cutting pattern and wherein the UV light illuminates the cutting pattern relative to the area proximate to the cutting member.

4. The handheld power tool of claim 1 wherein the UV light source is disposed on the tool housing generally proximate to the output member.

5. The handheld power tool of claim 4 wherein the UV light source is powered by a power source internal to the tool housing.

6. The handheld power tool of claim 5 wherein the UV light source is powered by a common power source as the motor.

7. The handheld power tool of claim 6, further comprising a switch to selectively electrically connect the UV light source to the common power source.

8. The handheld power tool of claim 4 wherein the UV light source is disposed in a light housing, the light housing being selectively attached to the tool housing.

9. The handheld power tool of claim 8 wherein the light housing is removably affixed to the tool housing by fasteners.

10. The handheld power tool of claim 9 wherein the light housing is portable and comprises an internal power source.

11. The handheld power tool of claim 1 wherein the handheld power tool comprises a jigsaw.

12. A handheld power tool kit comprising:
a tool housing having a trigger assembly;
a motor provided in the tool housing and coupled to an output member, the motor activating in response to movement of the trigger assembly;
a cutting member driven by the output member;
a black light disposed on the tool housing and emitting light adjacent to the cutting member; and
a writing instrument configured to mark a workpiece corresponding to a cutting pattern;
wherein the emitted light from the black light makes the marks of the cutting pattern appear optically brighter than areas of the workpiece in range of the emitted black light but without the marks.

13. The handheld power tool kit of claim 12 wherein the writing instrument comprises a highlighter.

14. The handheld power tool of claim 12 wherein the writing instrument comprising a pencil.

15. The handheld power tool kit of claim 12, further comprising a shoe member coupled to the tool housing wherein the black light projects UV light onto an area of the workpiece generally ahead of the shoe member in a cutting direction.

16. The handheld power tool kit of claim 15 wherein the black light is powered by a power source common with the motor.

17. The handheld power tool kit of claim 12 wherein the black light is disposed in a light housing, the light housing being selectively attached to the tool housing.

18. The handheld power tool kit of claim 17 wherein the light housing is portable and comprises an internal power source.

19. A method of cutting a workpiece with a handheld power tool, the method comprising:
marking a cutting pattern onto the workpiece with a writing instrument;
activating a UV light source associated with the handheld power tool, the UV light source emitting light that makes the markings of the cutting pattern appear optically brighter relative to the surrounding areas of the workpiece in range of the emitted light; and
cutting the workpiece with a cutting member on the tool while directing the cutting member substantially along the markings.

20. The method of claim 19, further comprising:
attaching the UV light source to the handheld power tool; and
activating a power switch associated with the UV light source to provide power to the UV light source.
